(19) United States
(12) Patent Application Publication
(10) Pub. No.: US 2026/0125092 A1
(43) Pub. Date: May 7, 2026

(54) Quick folding cart

(71) Applicant: Zhongshan Weihong Daily Necessities Co., Ltd., Zhongshan (CN)

(72) Inventor: Yidong JIANG, Zhongshan (CN)

(73) Assignee: Zhongshan Weihong Daily Necessities Co., Ltd., Zhongshan (CN)

(21) Appl. No.: 19/440,568

(22) Filed: Jan. 5, 2026

(30) Foreign Application Priority Data
Nov. 11, 2025 (CN) 202522391401.0

(51) Int. Cl. B62B 3/02

(52) U.S. Cl. CPC B62B 3/025

(57) ABSTRACT

The present invention discloses a quick folding cart, comprising a front frame, a rear frame, and two side frames capable of being unfolded and folded, the side frames being arranged between the front frame and the rear frame. A folding device is configured between the two side frames for driving the front frame and the rear frame to retract to each other and further folding the side frames. During folding, the front frame, rear frame, and side frame are capable of being synchronized and folded together through the folding device, which only requires a single trigger to complete the overall folding, significantly improving folding efficiency; After folding, it is easy to store and carry, and when unfolded, it is capable of maintaining the stability of the frame, fully meeting users' needs for convenience and lightweight, and comprehensively optimizing the user experience.

### RELATED APPLICATIONS

The present patent document claims the benefit of priority to Patent Application No. 202522391401.0, filed November 11, 2025, and entitled “QUICK FOLDING CART,” the entire contents of each of which are incorporated herein by reference.

### BACKGROUND

### 1. Technical Field

This present invention relates to the field of folding cart technology, particularly to a quick folding cart.

### 2. Background Information

Folding carts have significant advantages in daily use scenarios due to their foldable nature. After folding, its volume is significantly reduced, and the folded state is lightweight and easy to carry. It can be stored in the trunk of cars, in corners of homes, or in storage areas on public transportation, and can be quickly unfolded and put into use. It is easy to operate and effectively solves the pain points of large space occupation and inconvenient use of traditional carts.

However, the folding mechanism of traditional folding carts still has the drawback of inconvenient operation. At present, most designs adopt an independent button unlocking scheme, which requires users to cooperate with two hands to complete the folding: one hand fixes the frame to maintain stability, and the other hand needs to accurately press a specific position button to trigger unlocking. This operation mode is cumbersome and affects the user experience. Based on this, there is an urgent need for a new type of quick folding cart.

### BRIEF SUMMARY

To solve the above technical problems, the present invention proposes a quick folding cart.

This invention is implemented by the following technical solutions:

A quick folding cart comprising a front frame, a rear frame, and two side frames capable of being unfolded and folded between the front frame and the rear frame. A folding device is configured between the two side frames for driving the front frame and the rear frame to retract to each other and further folding the side frame.

With the above solution, the front frame, rear frame, and side frame are capable of being synchronized and folded together through the folding device, which only requires a single trigger to complete the overall folding, significantly improving folding efficiency; After folding, it is easy to store and carry, and when unfolded, it is capable of maintaining the stability of the frame, fully meeting users' needs for convenience and lightweight, and comprehensively optimizing the user experience.

In the quick folding cart as described above, each side frame comprising a front top rod and a front bottom rod respectively pivotally connected to upper and lower sides of the front frame at their front ends, a rear top rod and a rear bottom rod respectively pivotally connected to upper and lower sides of the rear frame at their rear end, and a locking mechanism for restricting or releasing a rotation between the front bottom rod and the front frame, and a rotation between the rear bottom rod and the rear frame. A first linkage element is configured between the front top rod and the rear top rod and respectively pivotally connected with the front top rod and the rear top rod on a same side, and a second linkage element is configured between the front bottom rod and the rear bottom rod respectively pivotally connected with the front bottom rod and the rear bottom rod on a same side, the folding device is configured for driving the locking mechanism to release the rotation restriction.

In the quick folding cart as described above, the folding device comprises two first folding rods respectively arranged between the two front bottom rods and between the two rear bottom rods, and a lifting component arranged between the two first folding rods for driving the locking mechanism to release the rotation restriction. When the lifting component is pulled, the locking mechanism is subjected to a force and releases restriction to the rotation between the front bottom rod and the front frame, and the rotation between the rear bottom rod and the rear frame, thereby causing the front bottom rod and the rear bottom rod to complete a folding of the cart.

In the quick folding cart as described above, the locking mechanism comprises a first connecting column arranged between the first linkage element and the second linkage element located on the same side, a first folding pivot seat fixed on the first connecting column, and a locking sleeve sliding on the front and rear bottom rods. A first side connecting rod is arranged between the first folding pivot seat and the locking sleeve, and pivotally connected with the first folding pivot seat and the locking sleeve. The locking mechanism further comprises locking component disposed within the front bottom rod and the rear bottom rod on one side away from a folding direction of the folding device, wherein the locking components are configured for limiting the locking sleeve sliding on the front bottom rod or the rear bottom rod.

In the quick folding cart as described above, the locking mechanism comprises a second connecting column connected to the first linkage element at one end, and a second folding pivot seat fixed on the other end of the second connecting column. The locking mechanism further comprises a locking sleeve sliding on the front bottom rod and the rear bottom rod. A first side connecting rod is arranged between the second folding pivot seat and the locking sleeve and pivotally connected with the second folding pivot seat and the locking sleeve, and the locking mechanism further comprises locking components disposed within the front bottom rod and the rear bottom rod on one side away from a folding direction of the folding device, wherein the locking components are configured for limiting the locking sleeve sliding on the front bottom rod or the rear bottom rod.

The quick folding cart as described above has a first intermediate rod is configured between the first side connecting rod and the front bottom rod, which is respectively pivotally connected to the first side connecting rod and the front bottom rod, and/or, a first intermediate rod is configured between the first side connecting rod and the rear bottom rod, which is respectively pivotally connected to the first side connecting rod and the rear bottom rod. One end side of the first intermediate rod is pivotally connected to a middle section of the first side connecting rod, and the other end side is pivotally connected to the front or rear bottom rods.

In the quick folding cart as described above, the locking mechanism comprises a second connecting column connected to the first linkage element at one end, and a second folding pivot seat fixed on the other end of the second connecting column. The locking mechanism further comprises a second sliding sleeve capable of sliding on two sides of the front frame and on two sides of the rear frame. A second side connecting rod is arranged between the second folding pivot seat and the second sliding sleeve and pivotally connected with the second folding pivot seat and the second sliding sleeve, the second side connecting rod is equipped with a pivot hole. The locking mechanism further comprises a locking sleeve that slides on the front bottom rod and the rear bottom rod, one end of the locking sleeve is pivotally connected to one end of a second intermediate rod, and the other end of the second intermediate rod pivotally connects and rotates with the pivot hole, the locking mechanism further comprises locking component disposed within the front bottom rod and the rear bottom rod on one side away from a folding direction of the folding device, the locking components are configured limiting the sliding of the locking sleeve on the front bottom rod or the rear bottom rod.

In the quick folding cart as described above, each first folding rod is configured with a sliding groove, and the folding device further comprises two first sliding sleeves respectively slidingly arranged on each first folding rod, and the first sliding sleeve is configured to slide within a range of the sliding groove, and the lifting component is pivotally connected to each first sliding sleeve, the folding device further comprises a first driving element arranged inside the first sliding sleeve and sliding with the first sliding sleeve , a first connecting element is configured between the first driving element and locking component for connecting the first driving element and locking component, when the lifting component is pulled, the locking component release restriction to the locking sleeve.

In the quick folding cart as described above, wherein the locking component is configured with a movable cavity and a movable hole connected to the movable cavity, and the locking component further comprises a stopper piece that slides in the movable cavity when pulled by the first connecting element, the shape of the stopper piece corresponds to the movable hole and is capable of blocking the sliding of the locking sleeve, a reset component is configured between the stopper piece and the movable cavity for resetting the stopper piece and further re-limiting the sliding of the locking sleeve.

In the quick folding cart as described above, wherein the two first folding rods are symmetrical about the first linkage element or symmetrical about the second linkage element, the upper and lower sides of the front frame are fixed with first upper pivot joint seats and first lower pivot joint seats respectively pivotally connected to the front top rod and the front bottom rod, and the upper and lower sides of the rear frame are fixed with second upper pivot joint seats and second lower pivot joint seat respectively pivotally connected to the rear top rod and the rear bottom rod.

Compared with the existing technology, the quick folding cart proposed by the present invention has the following beneficial effects:

The quick folding cart of the present invention, during folding the front frame, rear frame, and side frame are capable of being synchronized and folded together through the folding device, which only requires a single trigger to complete the overall folding, significantly improving folding efficiency; After folding, it is easy to store and carry, and when unfolded, it is capable of maintaining the stability of the frame, fully meeting users' needs for convenience and lightweight, and comprehensively optimizing the user experience.

### BRIEF DESCRIPTION OF THE DRAWINGS

In order to provide a clearer explanation of the technical solution in the embodiments of the present invention, a brief introduction will be given to the accompanying drawings required for the description of the embodiments.

FIG. 1 is a schematic structural view of the first embodiment of the present invention;

FIG. 2 is a schematic structural view from another perspective of FIG. 1;

FIG. 3 is a schematic structural view of the partial side frame, locking mechanism, and folding device in the first embodiment of the present invention;

FIG. 4 is a schematic exploded view of FIG. 3;

FIG. 5 is a schematic structural view of the locking component of the present invention;

FIG. 6 is a schematic cross-sectional view of FIG. 5;

FIG. 7 is a schematic structural view of embodiment two of the present invention;

FIG. 8 is a schematic structural view of embodiment three of the present invention;

FIG. 9 is a schematic structural view of embodiment four of the present invention;

FIG. 10 is a schematic structural view of embodiment five of the present invention;

FIG. 11 is a schematic partial structural view of the side frame, the locking mechanism, and the folding device in embodiment five of the present invention;

FIG. 12 is a schematic exploded view of FIG. 11.

The reference numbers correspond as follows:

1. Front frame; 11. First upper pivot joint seat; 12. First lower pivot joint seat; 2. Rear frame; 21. Second upper pivot joint seat; 22. Second lower pivot joint seat; 3. Side frame; 31. Front top rod; 32. Front bottom rod; 33. Rear top rod; 34. Rear bottom rod; 35. Locking mechanism; 351. First connecting column; 352. First folding pivot seat; 353. Locking sleeve; 354. First side connecting rod; 355. Locking component; 3551. movable cavity; 3552. movable hole; 3553. stopper piece; 3554. reset component; 3555. movable platform; 356. Second connecting column; 357. Second folding pivot seat; 3581. First intermediate rod; 3582. Second intermediate rod; 359. Second side connecting rod; 3591. pivot hole; 36. First linkage element; 37. Second linkage element; 38. Stop rod; 4. Folding device; 41. First folding rod; 411. Sliding groove; 42. Lifting component; 43. First sliding sleeve; 44. First driving element; 45. First connecting element; 46. Second folding rod; 461. Locking groove; 47. Third sliding sleeve; 471. Pulling component; 48. Second driving element; 49. Second connecting element; 50. Second sliding sleeve.

### DETAILED DESCRIPTION OF THE DRAWINGS AND THE PRESENTLY PREFERRED EMBODIMENTS

To make the technical problems solved by this invention, the technical solutions, and the beneficial effects clearer and more understandable, the following provides a further detailed description of this invention with reference to the accompanying drawings and embodiments. It should be understood that the specific embodiments described here are merely used to explain this invention and are not intended to limit it.

### Embodiment 1

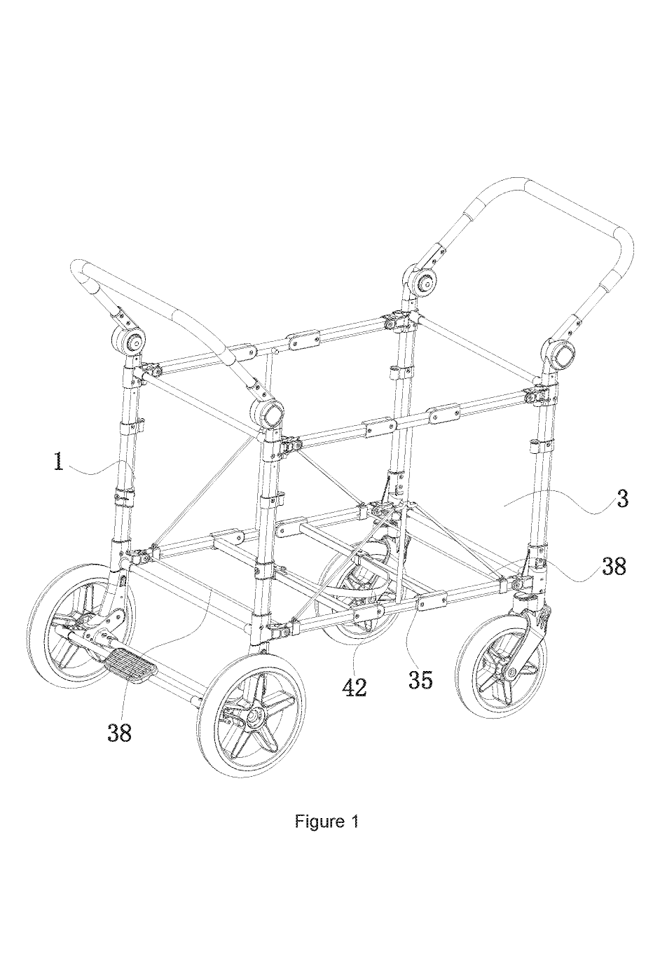

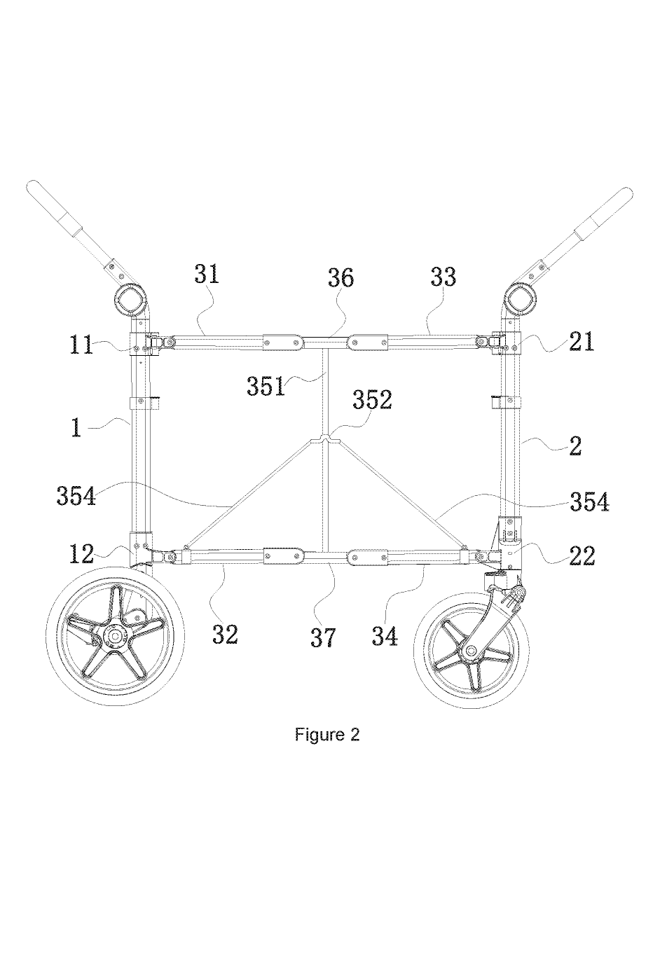

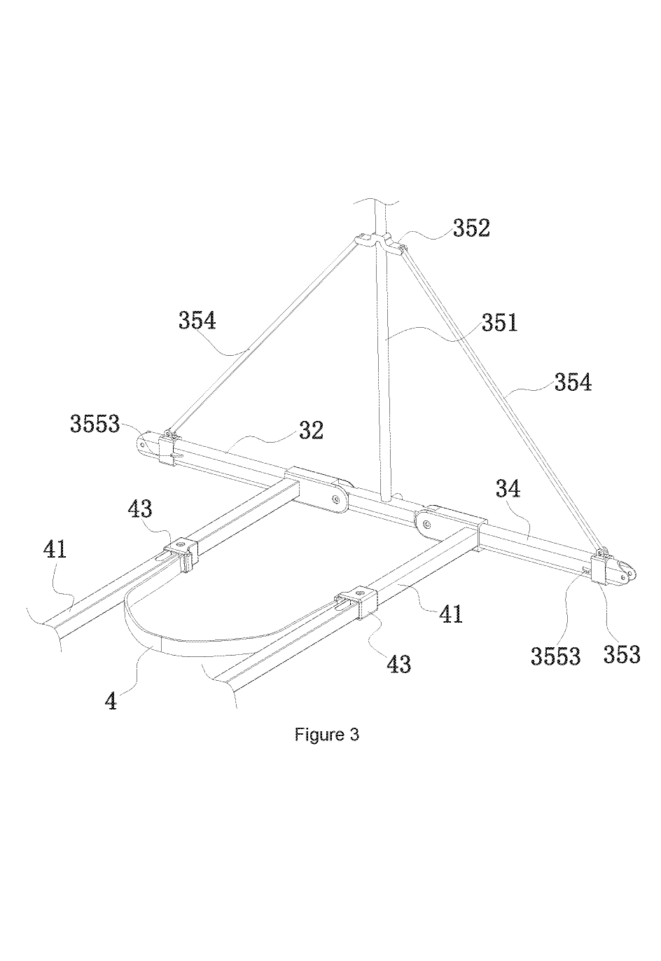

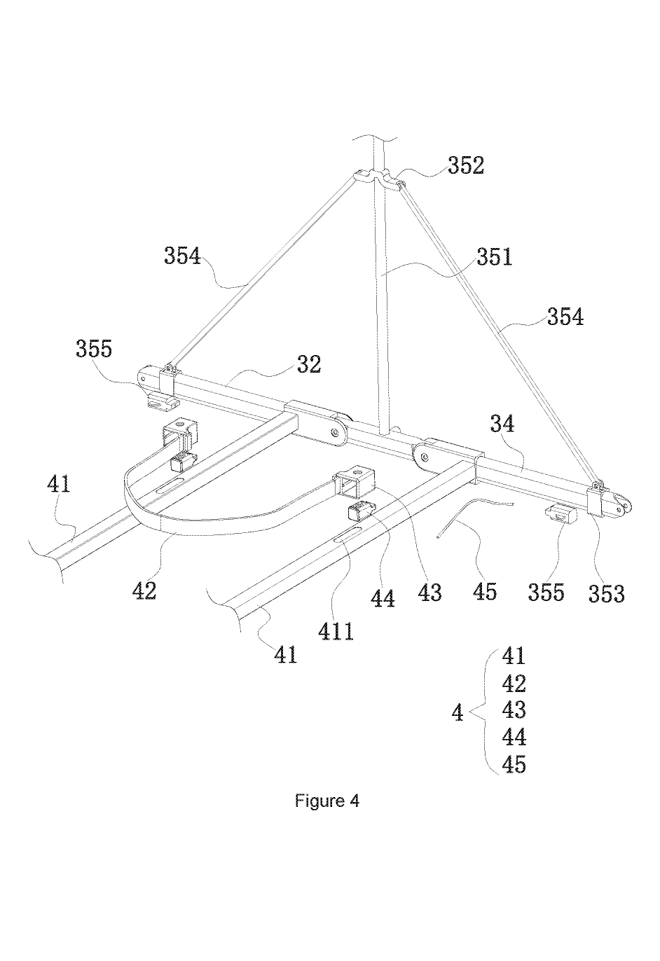

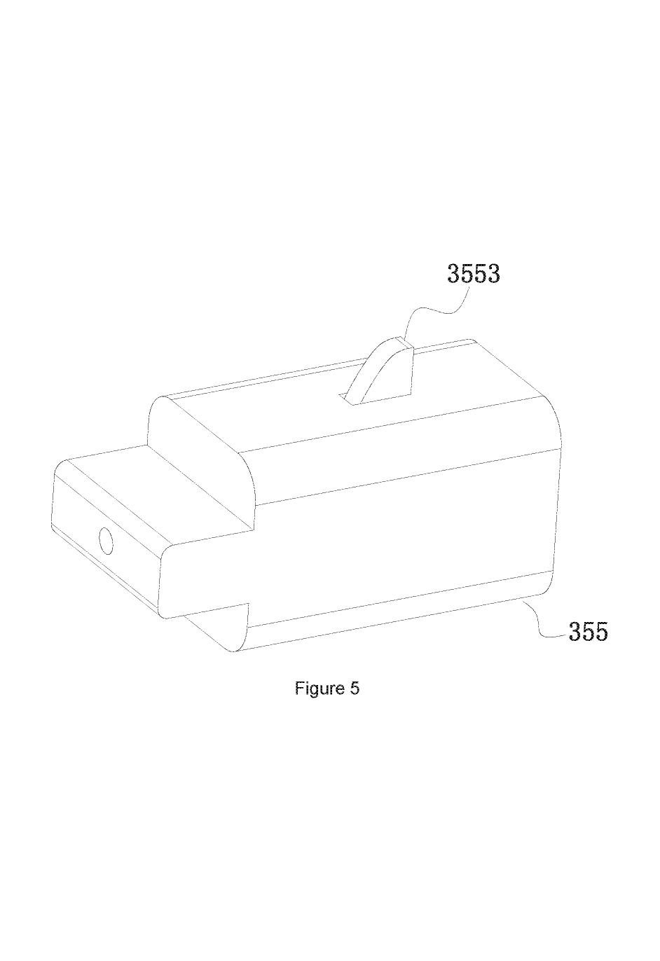

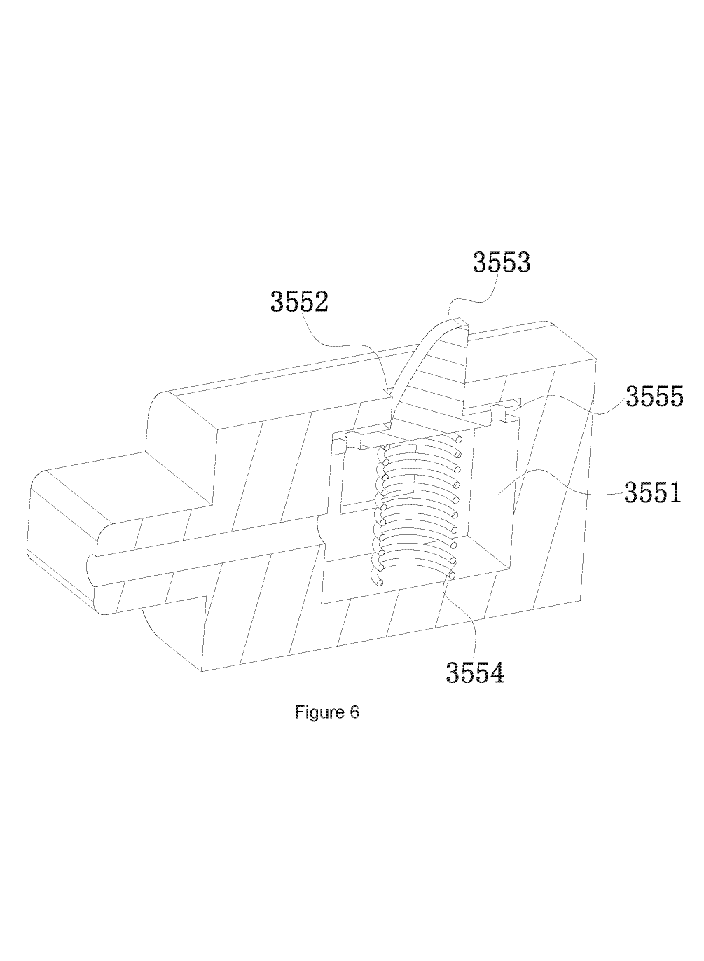

As shown in FIGS. 1 to 6, a quick folding cart comprises a front frame 1, a rear frame 2, and two side frames 3 capable of being unfolded and folded between the front frame 1 and the rear frame 2. A folding device 4 is configured between the two side frames 3 for driving the front frame 1 and the rear frame 2 to retract to each other and further folding the side frames 3.

Based on the above overall idea, the front frame 1, rear frame 2 and side frame 3 are capable of being synchronized and folded together through the folding device 4, which only requires a single trigger to complete the overall folding, significantly improving the folding efficiency. After folding, the volume is compact and easy to store and carry, fully meeting users' needs for convenience and lightweight, and comprehensively optimizing the user experience.

Specifically, each of the side frames 3 comprises a front top rod 31 and a front bottom rod 32 that are respectively pivotally connected to the upper and lower sides of the front frame 1 at their front ends, a rear top rod 33 and a rear bottom rod 34 that are respectively pivotally connected to the upper and lower sides of the rear frame 2 at their rear ends, and a locking mechanism 35 for restricting or releasing a rotation between the front bottom rod 32 and the front frame 1, and a rotation between the rear bottom rod 34 and the rear frame 2. A first linkage element 36 is configured between the front top rod 31 and the rear top rod 33 on a same side and respectively pivotally with the front top rod 31 and the rear top rod 33, and a second linkage element 37 is configured between the front bottom rod 32 and the rear bottom rod 34 on a same side, and respectively pivotally connected with the front bottom rod 32 and the rear bottom rod 34. The folding device 4 is configured for driving the locking mechanism 35 to release the rotation restriction, when the locking mechanism 35 releases a rotational constraint between the front bottom rod 32 and the front frame 1, and between the rear bottom rod 34 and the rear frame 2, the folding device 4 further drives the front bottom rod 32 and the rear bottom rod 34 to complete a folding of the cart.

Through the coordinated action of the linkage structure of the side frame 3 and the locking mechanism 35, the cart can be efficiently folded. After the locking mechanism 35 release restriction to the rotation, the folding device 4 drives the front bottom rod 32 and the rear bottom rod 34 to cooperate and fold, and cooperates with the pivot design of the front top rod 31, the rear top rod 33, and the linkage elements to form a stable folding path. The locking mechanism 35 can drive the first linkage element 36 and the second linkage element 37 to cooperate and move synchronously during the folding process, improving the smoothness of operation and structural stability, simplifying user operation steps, enhancing portability and user experience.

In the setting of the side frame 3 mentioned above, it is preferred that the folding device 4 comprises two first folding rods 41 respectively arranged between the two front bottom rods 32 and between the two rear bottom rods 34, and a lifting component 42 arranged between the two first folding rods 41 for driving the locking mechanism 35 to release the rotation restriction. When the lifting component 42 is actuated, the locking mechanism 35 is subjected to a force and releases the rotational constraint between the front bottom rod 32 and the front frame 1, and between the rear bottom rod 34 and the rear frame 2, thereby causing the front bottom rod 32 and the rear bottom rod 34 to complete a folding of the cart.

In this process, the quick folding of the cart is capable of achieving through the synergistic effect of the lifting component 42 and other structures. The lifting component 42 drives the locking mechanism 35 to release the rotation restriction, and the first folding rod 41 drives the front bottom rod 32 and the rear bottom rod 34 to move synchronously. At the same time, the front top rod 31 and the rear top rod 33 further move synchronously, forming an efficient folding path. This structure simplifies the folding operation steps, and only requires a single lifting to complete the folding of the entire cart, improving the convenience of folding the cart.

To further expand the performance of the quick folding cart, it is preferred that the locking mechanism 35 comprises a first connecting column 351 arranged between the first linkage element 36 and the second linkage element 37 located on the same side, a first folding pivot seat 352 fixed on the first connecting column 351, and a locking sleeve 353 sliding on the front bottom rod 32 and the rear bottom rod 34. A first side connecting rod 354 is arranged between the first folding pivot seat 352 and the locking sleeve 353 and pivotally connected with the first folding pivot seat 352 and the locking sleeve 353, and the locking mechanism 35 further comprises locking components 355 disposed within the front bottom rod 32 and the rear bottom rod 34 on one side away from a folding direction of the folding device 4, wherein the locking components 355 are configured for limiting the locking sleeve 353 sliding on the front bottom rod 32 or the rear bottom rod 34.

The locking mechanism 35 achieves precise closing control through multi component linkage. Specifically, when the quick folding cart is in the unfolded state, the sliding of the locking sleeve 353 is limited to ensure the stability of the cart base. At this point, external forces are incapable of forcibly folding the cart, preventing interference with the locking state and enhancing locking reliability. When the quick folding cart needs to be folded, the front bottom rod 32 on the side away from the folding direction of the lifting component 42 and the locking component 355 in the rear bottom rod 34 are released from the rotation limit by pulling the lifting component 42. At the same time, the first connecting column 351 and the first folding pivot seat 352 coordinate to transmit the driving force to realize the folding of the cart. The first side connecting rod 354 is designed with a pivotally connection to optimize the force transmission path, and is combined with the folding device 4 to achieve smooth operation of lifting, unlocking, and synchronized folding, reducing the risk of improper operation, enhancing the durability of the structure, ensuring that the folding cart maintains stable performance during frequent folding, and improving the user experience.

In the setting of the locking mechanism 35 mentioned above, it is preferred that each first folding rod 41 is configured with a sliding groove 411, and the folding device 4 further comprises two first sliding sleeves 43 respectively slidingly arranged on each first folding rod 41, and the first sliding sleeve 43 is configured to slide within a range of the sliding groove 411, and the lifting component 42 is pivotally connected to each first sliding sleeve 43, the folding device 4 further comprises a first driving element 44 arranged inside the first sliding sleeve 43 and sliding with the first sliding sleeve 43, a first connecting element 45 is configured between the first driving element 44 and locking component 355 for connecting the first driving element 44 and locking component 355, when the lifting component 42 is actuated, the locking component 355 release restriction to the locking sleeve 353 to achieve the release of the rotation restriction between the front bottom rod 32 and the front frame 1, and the rotation restriction between the rear bottom rod 34 and the rear frame 2.

Through the sliding cooperation between the sliding groove 411 and the first sliding sleeve 43, precise transmission of lifting force is achieved. When pulling the lifting component 42, the first driving element 44 drives the locking component 355 through the first connecting element 45 to release the sliding restriction of the locking sleeve 353, triggering the rotation restriction of the front bottom rod 32 and the rear bottom rod 34 to be released, and cooperating with the first folding rod 41 to complete the folding of the cart; In addition, the sliding groove 411 limits the sliding range for ensuring operational controllability.

In addition, the locking component 355 is configured with a movable cavity 3551 and a movable hole 3552 pivotally connected to the movable cavity 3551, and the locking component 355 further comprises a stopper piece 3553 that slides in the movable cavity 3551 when pulled by the first connecting element 45, the shape of the stopper piece 3553 corresponds to the movable hole 3552 and is capable of blocking the sliding of the locking sleeve 353, a reset component 3554 is configured between the stopper piece 3553 and the movable cavity 3551 for resetting the stopper piece 3553 and further re-limiting the sliding of the locking sleeve 353. When the stopper piece 3553 extends out of the movable hole 3552, the stopper piece 3553 limits the sliding of the locking sleeve 353. When the stopper piece 3553 retracts into the movable hole 3552, the stopper 3553 releases the restriction on the sliding of the locking sleeve 353.

More preferably, in order to further enhance the stability of the locking mechanism 35, a stop rod 38 is provided between the two front bottom rods 32 and/or between the two rear bottom rods 34, the stop rod 38 is configured to cooperate with the locking components 355 for limiting the locking sleeves 353.

When the quick folding car is in the fully unfolded state, each locking sleeve 353 is pressed on one side by the stop rod 38 and on the opposite side by the corresponding locking component 355, thereby firmly maintaining the car in the unfolded state; during folding of the quick folding car, the locking component 355 release the constraint on the locking sleeves 353, allowing the two locking sleeves 353 to move toward each other, that is, slide in the direction toward the first connecting column 351, thereby driving the car to complete the folding process.

It should be pointed out that based on the overall design concept mentioned above, the technical solution of this application is capable of adopting various specific implementation structures, forms, or configuration sequences. For example, the stopper piece 3553 has a block structure with a cross-sectional shape of one side arc-shaped and one side vertical, corresponding to the size of the movable hole 3552. One side of the stopper piece 3553 is configured with a movable platform 3555 for contacting the first connecting element 45 and the reset component 3554, and the movable platform 3555 is capable of sliding in the movable cavity 3551. The vertical side of the cross-section of the stop piece 3553 faces the locking sleeve 353, in order that when the cart is in the deployed state, the stop piece 3553 is capable of limit the sliding of the locking sleeve 353. When the cart transitions from the folded state to the deployed state, the locking sleeve 353 is capable of contacting the arc-shaped structure of the stop piece 3553 and pressing it into the movable hole 3552, thereby achieving the locking sleeve 353 to cross the range of the movable hole 3552 until the cart is fully deployed, and the stop piece 3553 is capable of being reset under the top pressure of the reset piece 3554 to continue for limiting the sliding of the locking sleeve 353.

The locking component 355 is capable of achieving automatic reset function through the cooperation of the movable cavity 3551 and the reset component 3554, improving the reliability of the folding. The stopper piece 3553 controls the sliding state of the locking sleeve 353: when pulling, the first connecting element 45 pulls the stopper piece 3553 to retract, releasing the sliding restriction on the locking sleeve 353; When canceling the pulling of first connecting element 45, reset component 3554 drives the stopper piece 3553 to reset, ensuring precise locking next time. This structure enables smooth operation of "pull unlock, release reset", reducing manual reset steps for users, while ensuring stable performance of the locking mechanism 35 during frequent use, optimizing the safety and user experience of the folding cart.

Among them, it should be pointed out that the sliding range of the sliding groove 411 corresponds to the movable range of the stopper piece 3553, so that when pulling the lifting component 42, the stopper piece 3553 is capable of being folded into the movable hole 3552 to unlock the sliding restriction of the locking sleeve 353.

Preferably, the two first folding rods 41 are symmetrical about the first linkage element 36 or symmetrical about the second linkage element 37. The symmetrically arranged first folding rod 41 enhances structural stability through mechanical balance design; In addition, the first folding rod 41 is symmetrically arranged with respect to the first linkage element 36 or the second linkage element 37, so that the folding cart is uniformly stressed during the folding process, reducing the risk of deformation or jamming caused by stress concentration on one side. The symmetrical structure is combined with the pivot design of the linkage element to form a synchronized folding path, ensuring the coordinated movement of the front bottom rod 32 and the rear bottom rod 34, and improving the smoothness and operation feel of the folding process; At the same time, symmetrical layout simplifies manufacturing and assembly processes, reduces production errors, and improves product consistency. In summary, this design not only ensures the reliability of folding, but further optimizes the user experience, avoids safety risks caused by structural imbalance, and enhances the durability and stability of the folding cart during frequent use.

To further expand the performance of the quick folding cart, specifically, the upper and lower sides of the front frame 1 are fixed with first upper pivot joint seats 11 and first lower pivot joint seats 12 respectively pivotally connected to the front top rod 31 and the front bottom rod 32, and the upper and lower sides of the rear frame 2 are fixed with second upper pivot joint seats 21 and second lower pivot joint seat 22 respectively pivotally connected to the rear top rod 33 and the rear bottom rod 34.

By precise positioning and layout of the upper and lower pivot joint seats, the stability and smooth folding of the folding cart structure are enhanced. Specifically, the first upper pivot joint seat 11 and the first lower pivot joint seat 12, and the second upper pivot joint seat 21 and the second lower pivot joint seat 22, are respectively fixed to the upper and lower ends of the front frame 1 and the rear frame 2, forming multi-directional support points to disperse the force during the folding process, avoid single point stress concentration, and improve the durability of the rod rotation. The pivot design of the pivot seat with the top and bottom rods, combined with the linkage element and locking mechanism 35, ensures synchronous linkage of each rod during folding, reduces the risk of jamming, improves the smooth hand feel and safety of user operation, and meets the requirements of efficient folding and durable and reliable products.

The working principle of this embodiment is as follows:

When the quick folding cart is in the unfolded state, the front bottom rod 32 and the rear bottom rod 34 on the side away from the direction of force exerted by the lifting element 42 are respectively pivotally connected to the first lower pivot joint seat 12 and the second lower pivot joint seat 22, and the front bottom rod 32 is equipped with a locking component 355 that limits its rotation with the first lower pivot joint seat 12, and the rear bottom rod 34 is further equipped with a locking component 355 that limits its rotation with the second lower pivot joint seat 22. As one side of the first side connecting rod 354 is pivotally connected to the fixed first folding pivot seat 352, and the other side is pivotally connected to the locking sleeve 353, the locking sleeve 353 is limited by the locking component 355, which limits the movement of the first side connecting rod 354. At this point, the two of front the bottom rod 32 and the rear bottom rod 34 are incapable of rotating compared to the first lower pivot joint seat 12 and the second lower pivot joint seat 22, thus achieving self-locking in the deployed state.

When it is necessary to fold the quick folding cart, pull the lifting component 42, which drives the first driving element 44, and at the same time drives the locking component 355 through the first connecting element 45, so that the stopper piece 3553 retracts into the range of the movable hole 3552. At this time, the locking sleeves 353 are capable of sliding beyond the range of the locking component 355. Continue to pull the lifting component 42 until it reaches the side wall of the sliding groove 411. Pulling again will further pull the first folding rod 41 and drive the front bottom rod 32 and the rear bottom rod 34 to rotate, and with the sliding of the locking sleeve 353, the front frame 1, the rear frame 2, and the side frame 3 will be folded.

When the lifting element 42 is released, the stopper piece 3553 extends out of the range of the movable hole 3552 under the action of the reset component 3554. When the quick folding cart needs to be unfolded, press the first linkage element 36 or the front top rod 31 or the rear top rod 33 to rotate the front top rod 31, front bottom rod 32, rear top rod 33, and rear bottom rod 34 in the opposite direction of the folding direction; When the locking sleeve 353 contacts the stopper piece 3553, due to the inclined surface of the stopper piece 3553, the locking sleeves 353 are capable of pressing the stopper piece 3553 into the movable hole 3552 along the unfolding direction until the locking sleeve 353 returns to the fully unfolded position of the cart, at this time, the locking sleeves 353 crosse the range of the movable hole 3552, and the stopper piece 3553 extends out of the range of the movable hole 3552 again, thereby restricting the sliding of the locking sleeve 353 again.

In summary, when the quick folding cart is folding, the front frame 1, rear frame 2 and side frame 3 are capable of being synchronized and folded together through the folding device 4, which only requires a single trigger to complete the overall folding, significantly improving the folding efficiency; The structure adopts a double-sided symmetrical design to enhance the stability of the collection and effectively avoid problems such as jamming or displacement; After folding, it is easy to store and carry, and when unfolded, it is capable of maintaining the stability of the frame, fully meeting users' needs for convenience and lightweight, and comprehensively optimizing the user experience.

### Embodiment 2

Differing from Embodiment 1, the structure of the locking mechanism 35 is different.

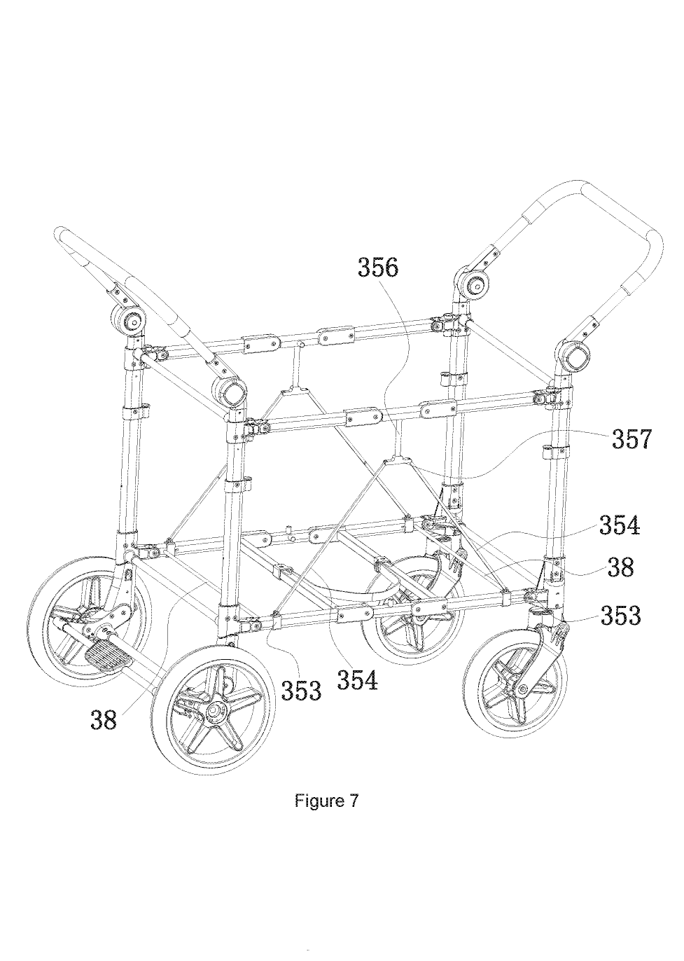

Specifically, referring to FIG. 7 and the view of the locking component 355, the locking mechanism 35 comprises a second connecting column 356 connected to the first linkage element 36 at one end, and a second folding pivot seat 357 fixed on the other end of the second connecting column 356. The locking mechanism 35 further comprises a locking sleeve 353 sliding on the front bottom rod 32 and the rear bottom rod 34. A first side connecting rod 354 is arranged between the second folding pivot seat 357 and the locking sleeve 353, which is pivotally connected to the second folding pivot seat 357 and the locking sleeve 353. The locking mechanism 35 further comprises a locking component 355 disposed within the front bottom rod 32 and the rear bottom rod 34 on one side away from a folding direction of the folding device 4, wherein the locking components 355 are configured for limiting the locking sleeve 353 sliding on the front bottom rod 32 or the rear bottom rod 34.

The locking mechanism 35 achieves precise closing control through multi component linkage. Different from the locking mechanism 35 in Embodiment 1, that is, the setting of the second connecting column 356. In addition, when the quick folding cart is in the unfolded state, the sliding of the locking sleeve 353 is limited to ensure the stability of the cart base. At this point, external forces are incapable of forcibly folding the cart, preventing interference with the locking state and enhancing locking reliability. When it is necessary to fold the quick folding cart, pull the lifting component 42 to release the rotation restriction of the front bottom rod 32 and the locking component 355 inside the rear bottom rod 34 on the side away from the folding direction of the lifting component 42. At the same time, during sliding, drive the second folding pivot seat 357 to move towards the first linkage element 36 along with the second linkage element 37, and cooperate to fold the cart. The pivot design of the first side connecting rod 354 optimizes the force transmission path, and with the cooperation of the folding device 4, achieves smooth operation of lifting and unlocking, synchronous folding and closing, reduces the risk of improper operation, and enhances the durability of the structure, ensuring that the folding cart maintains stable performance during frequent folding, and improving the user experience.

### Embodiment 3

Differing from Embodiment 2, the structure of the locking mechanism 35 is different.

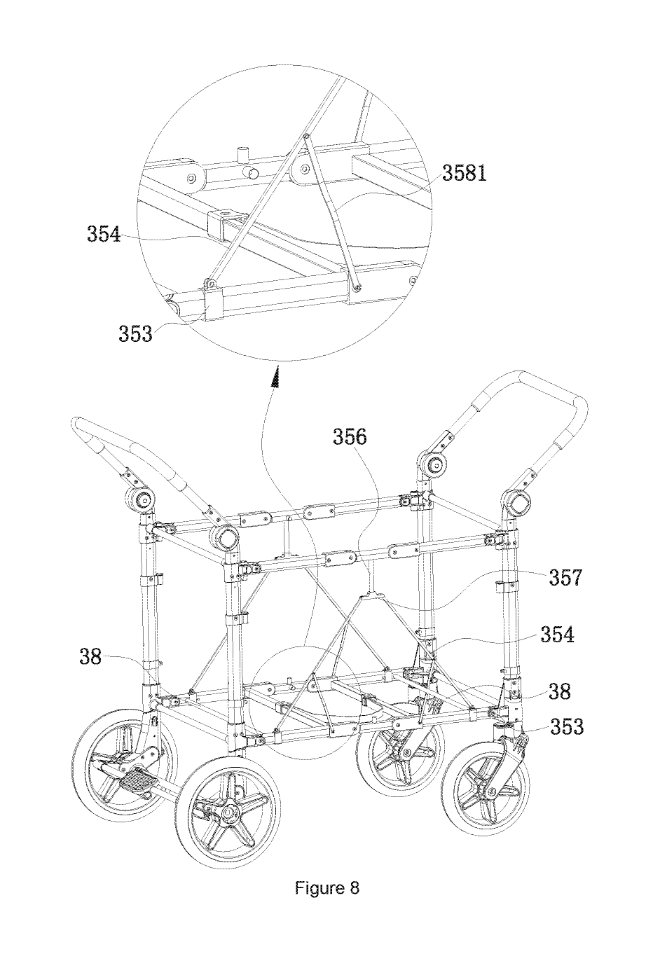

Specifically, referring to FIG. 8 and the view of the locking component 355, the locking mechanism 35 comprises a second connecting column 356 connected to the first linkage element 36 at one end, and a second folding pivot seat 357 fixed on the other end of the second connecting column 356, the locking mechanism 35 further comprises a locking sleeve 353 sliding on the front bottom rod 32 and the rear bottom rod 34,a first side connecting rod 354 is arranged between the second folding pivot seat 357 and the locking sleeve 353 and pivotally connected with the second folding pivot seat 357 and the locking sleeve 353, a first intermediate rod 3581 is configured between the first side connecting rod 354 and the front bottom rod 32, which is respectively pivotally connected to the first side connecting rod 354 and the front bottom rod 32, and/or, a first intermediate rod 3581 is configured between the first side connecting rod 354 and the rear bottom rod 34, which is respectively pivotally connected to the first side connecting rod 354 and the rear bottom rod 34, one end of the first intermediate rod 3581 is pivotally connected to a middle section of the first side connecting rod 354, and the other end is pivotally connected to the front or rear bottom rods.

The locking mechanism 35 further comprises a locking component 355 disposed within the front bottom rod 32 and the rear bottom rod 34 on one side away from a folding direction of the folding device 4, wherein the locking components 355 are configured for limiting the locking sleeve 353 sliding on the front bottom rod 32 or the rear bottom rod 34.

Different from the locking mechanism 35 in Embodiment 2, this design incorporates the first intermediate rod 3581. This first intermediate rod 3581 enables further driving of the first side connecting rod 354 to press against the second connecting column 356 after unlocking through the actuating lifting component 42, thereby enhancing the folding speed of the cart.

### Embodiment 4

Differing from Embodiment 2, the structure of the locking mechanism 35 is different.

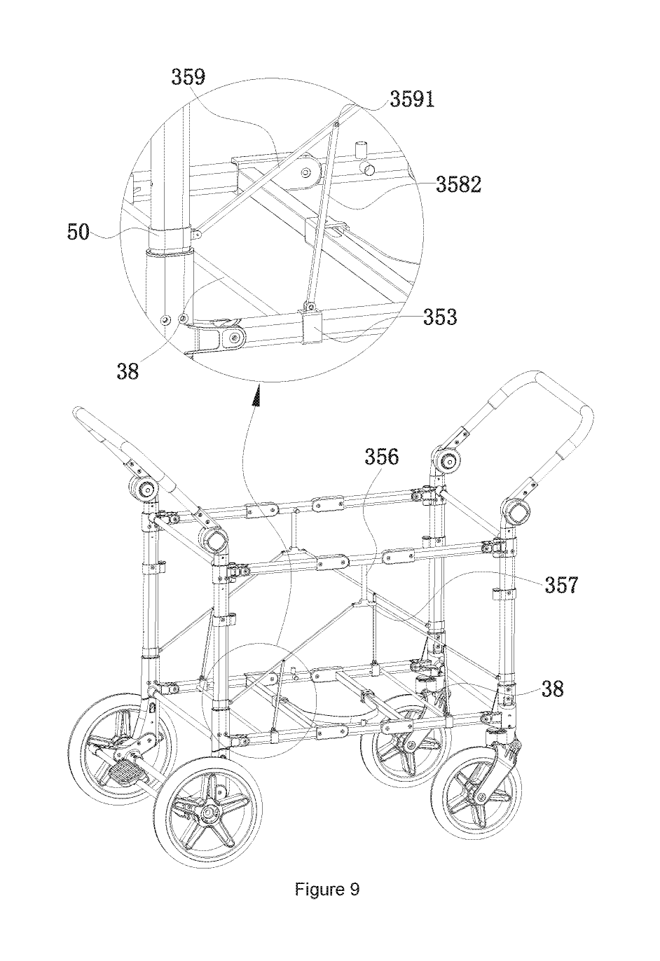

Specifically, referring to FIG. 9 and the view of the locking component 355, the locking mechanism 35 comprises a second connecting column 356 connected to the first linkage element 36 at one end, and a second folding pivot seat 357 fixed on the other end of the second connecting column 356. The locking mechanism 35 further comprises a second sliding sleeve 50 capable of sliding on two sides of the front frame 1 and on two sides of the rear frame 2, and a second side connecting rod 359 is arranged between the second folding pivot seat 357 and the second sliding sleeve 50 and pivotally connected with the second folding pivot seat 357 and the second sliding sleeve 50, the second side connecting rod 359 is equipped with a pivot hole 3591. A locking sleeve 353 sliding on the front bottom rod 32 and the rear bottom rod 34, one end of the locking sleeve 353 is pivotally connected to one end of a second intermediate rod 3582, and the other end of the second intermediate rod 3582 pivotally connects and rotates with the pivot hole 3591. The locking mechanism 35 further comprises locking components 355 disposed within the front bottom rod 32 and the rear bottom rod 34 on one side away from a folding direction of the folding device 4, the locking components 355 are configured limiting the sliding of the locking sleeve 353 on the front bottom rod 32 or the rear bottom rod 34.

The locking mechanism 35 achieves precise closing control through multi component linkage. Different from the locking mechanism 35 in Embodiment 2, that is, the linkage locking and unlocking settings are different. In addition, when the quick folding cart is in the unfolded state, the sliding of the locking sleeve 353 is limited to ensure the stability of the cart base. Due to the cooperation of the second side connecting rod 359 and the locked second middle rod 3582, At this point, external forces are incapable of forcibly folding the cart, preventing interference with the locking state and enhancing locking reliability. When it is necessary to fold the quick folding cart, pull the lifting component 42 to release the rotation restriction of the front bottom rod 32 and the locking component 355 inside the rear bottom rod 34 on the side away from the folding direction of the lifting component 42. At the same time, during sliding, drive the second folding pivot seat 357 to move towards the first linkage element 36 along with the second linkage element 37, and cooperate to fold the cart. The first side connecting rod 354 is designed with a pivotally connection to optimize the force transmission path, and is combined with the folding device 4 to achieve smooth operation of lifting, unlocking, and synchronized folding, reducing the risk of improper operation, enhancing the durability of the structure, ensuring that the folding cart maintains stable performance during frequent folding, and improving the user experience.

Among them, it should be pointed out that when the quick folding cart is in the unfolded state, the second sliding sleeve 50 is located on the side of the front frame 1 near the front bottom rod 32, or the second sliding sleeve 50 is located on the side of the rear frame 2 near the rear bottom rod 34.

### Embodiment 5

Differing from Embodiment 2, the structure of folding device 4 and the locking mechanism 35 is different.

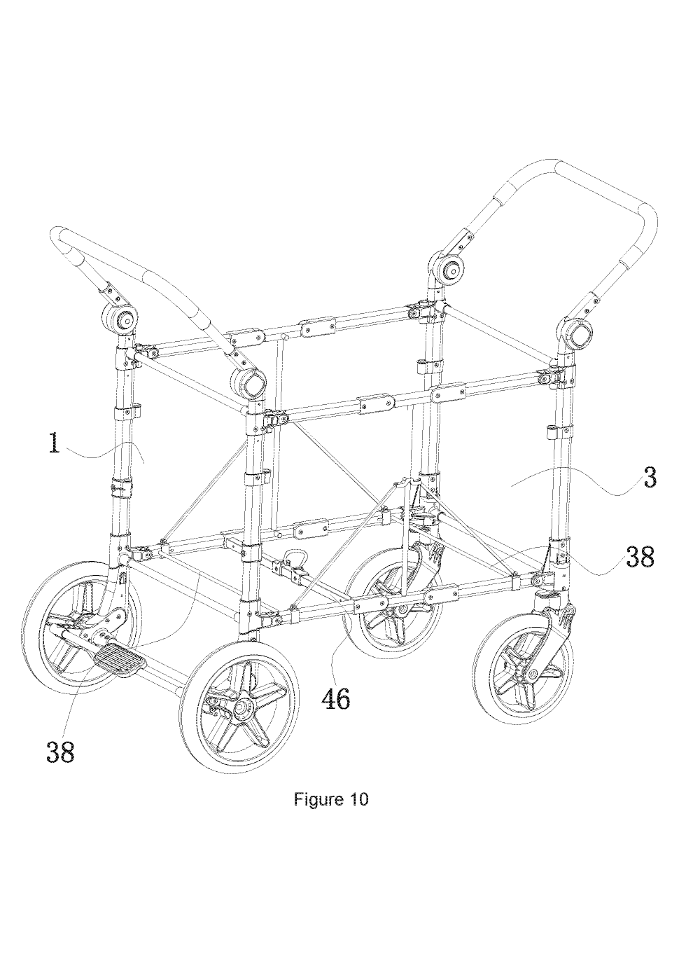

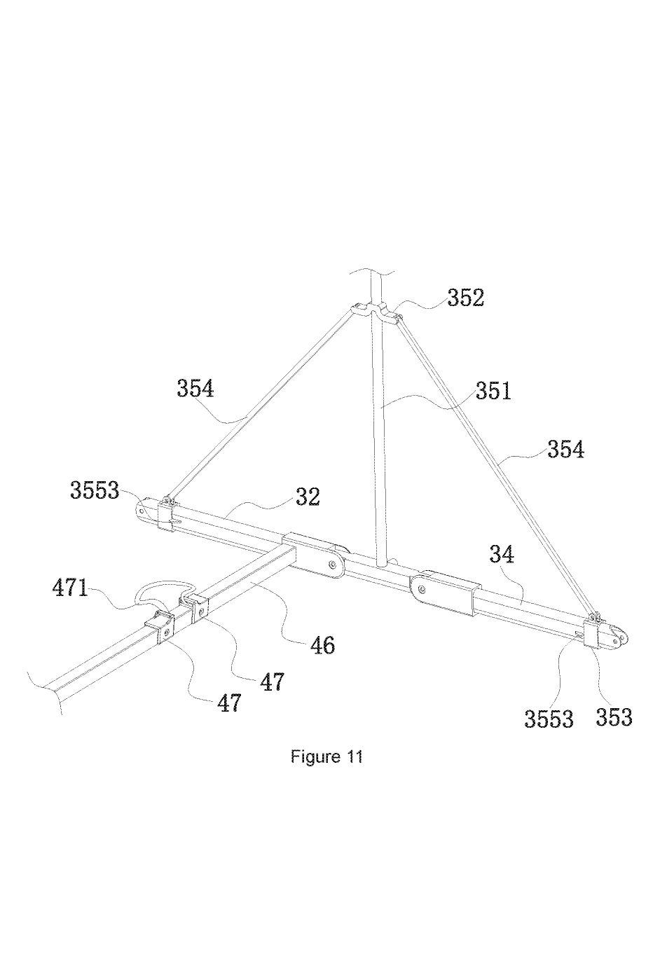

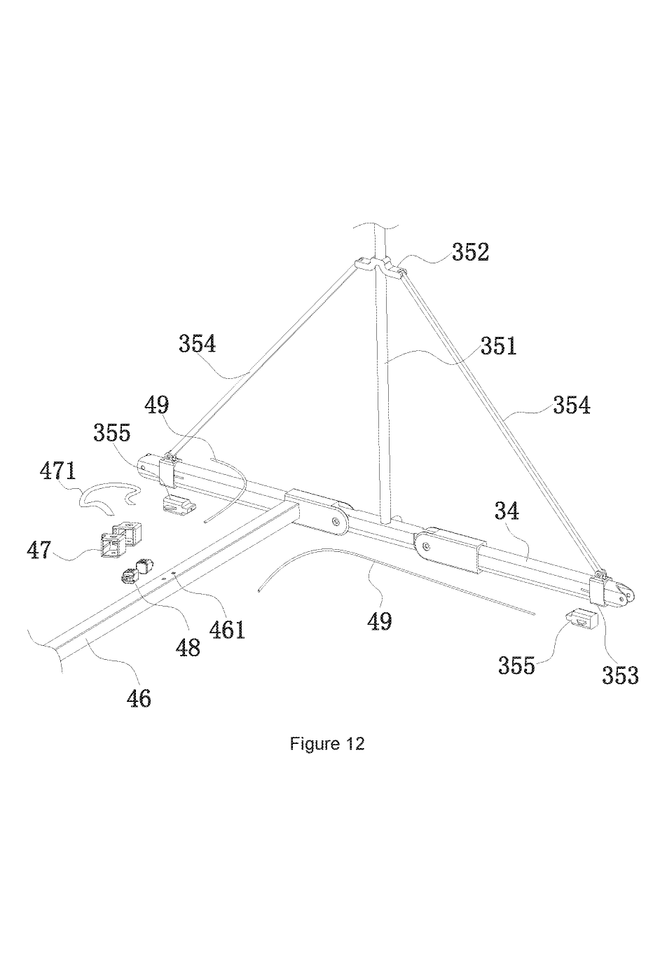

Specifically, referring to FIGS. 10 to 12, the folding device 4 comprises two second folding rods 46 respectively arranged between the two front bottom rods 32 and/or between the two rear bottom rods 34, two locking grooves 461 are formed on the second folding rods 46 at spaced intervals. The folding device 4 further comprises two third sliding sleeves 47 that correspond to the locking grooves 461 and are slidable within the corresponding locking grooves 461, and a pulling component 471 configured to drive the third sliding sleeves 47 and thereby actuate the locking mechanism 35 to release the rotational constraint. When the pulling component 471 is actuated, the locking mechanism 35 is subjected to a force and releases the rotational constraint between the front bottom rod 32 and the front frame 1, and between the rear bottom rod 34 and the rear frame 2, thereby causing the front bottom rod 32 and the rear bottom rod 34 to fold the cart.

Preferably, in order to further enhance the folding stability and speed of the quick folding cart, the second folding rod 46 is arranged between the two second linkage elements 37, such that when the pulling component 471 is actuated, the locking mechanism 35 is subjected to a force and releases the rotational constraint between the front bottom rod 32 and the front frame 1, and between the rear bottom rod 34 and the rear frame 2, thereby causing the front bottom rod 32 and the rear bottom rod 34 to fold the cart.

Furthermore, the folding device 4 further comprises two second driving elements 48, each respectively arranged inside the third sliding sleeve 47 and sliding with the third sliding sleeves 47, a second connecting element 49 is provided between each second driving element 48 and the corresponding locking component 355 on the same side, respectively, connecting the second driving elements 48 and the locking component 355. The second linkage elements 37, the second folding rod 46, the front bottom rod 32 and the rear bottom rod 34 are each provided with internal cavities that facilitate passage of the second connecting elements 49, thereby providing routing space for the second connecting elements 49. When the pulling component 471 is actuated, it drives the two third sliding sleeves 47 toward each other, thereby driving the second driving elements 48 toward each other. Further the second driving element 48 drives each of the two locking components 355 on each side frame 3 to move towards each other through the second connecting element 49, the locking mechanism 35 releases the locking sleeve 353 from its constrained state, thereby enabling the removal of the rotational restriction between the front bottom rod 32 and the front frame 1, and the rotational restriction between the rear bottom rod 34 and the rear frame 2.

This embodiment has made improvements based on the structure of Embodiment 1. It should be noted that the structural features of Embodiment 5 are also applicable to any of the foregoing embodiments, resulting in unlocking through the retraction device 4 and actuation of the cart into its folded state.

The foregoing descriptions present four exemplary embodiments of this application. Detailed explanations of configurations, specific structural arrangements, assembly methods, or connection modes serve solely to ensure sufficient disclosure and to enable those skilled in the art to practice the invention. They are not intended to limit the scope of protection of this application. Any modifications, equivalent substitutions, or improvements made within the spirit and scope of the invention shall fall within the scope of the appended claims.

1. A quick folding cart, comprising a front frame, a rear frame, and two side frames capable of being unfolded and folded between the front frame and the rear frame, wherein a folding device is configured between the two side frames for driving the front frame and the rear frame to retract to each other and further folding the side frames.

2. The quick folding cart according to claim 1, wherein each side frame comprises: a front top rod and a front bottom rod respectively pivotally connected to upper and lower sides of the front frame at their front ends, a rear top rod and a rear bottom rod respectively pivotally connected to upper and lower sides of the rear frame at their rear end, and a locking mechanism for restricting or releasing a rotation between the front bottom rod and the front frame, and a rotation between the rear bottom rod and the rear frame,
a first linkage element is configured between the front top rod and the rear top rod and respectively pivotally connected with the front top rod and the rear top rod on a same side, and a second linkage element is configured between the front bottom rod and the rear bottom rod and respectively pivotally connected with the front bottom rod and the rear bottom rod on a same side, the folding device is configured for driving the locking mechanism to release restriction to the rotation.

3. The quick folding cart according to claim 2, wherein the folding device comprises two first folding rods respectively arranged between the two front bottom rods and between the two rear bottom rods, and a lifting component arranged between the two first folding rods for driving the locking mechanism to release restriction to the rotation,
when the lifting component is actuated, the locking mechanism is subjected to a force and releases a rotational constraint between the front bottom rod and the front frame, and between the rear bottom rod and the rear frame, thereby causing the front bottom rod and the rear bottom rod to complete a folding of the cart.

4. The quick folding cart according to claim 3, wherein the locking mechanism comprises a first connecting column arranged between the first linkage element and the second linkage element located on the same side, and a first folding pivot seat fixed on the first connecting column, the locking mechanism further comprises a locking sleeve sliding on the front bottom rod and/or the rear bottom rod,
wherein a first side connecting rod is arranged between the first folding pivot seat and the locking sleeve and pivotally connected with the first folding pivot seat and the locking sleeve, and the locking mechanism further comprises locking components disposed within the front bottom rod and the rear bottom rod on one side away from a folding direction of the folding device, wherein the locking components are configured for limiting the locking sleeve sliding on the front bottom rod or the rear bottom rod.

5. The quick folding cart according to claim 3, wherein the locking mechanism comprises a second connecting column connected to the first linkage element at one end, and a second folding pivot seat fixed on the other end of the second connecting column, the locking mechanism further comprises a locking sleeve sliding on the front bottom rod and/or the rear bottom rod,
wherein a first side connecting rod is arranged between the second folding pivot seat and the locking sleeve and pivotally connected with the second folding pivot seat and the locking sleeve, and the locking mechanism further comprises locking components disposed within the front bottom rod and the rear bottom rod on one side away from a folding direction of the folding device, wherein the locking components are configured for limiting the locking sleeve sliding on the front bottom rod or the rear bottom rod.

6. The quick folding cart according to claim 5, wherein a first intermediate rod is configured between the first side connecting rod and the front bottom rod, which is respectively pivotally connected to the first side connecting rod and the front bottom rod, and/or, a first intermediate rod is configured between the first side connecting rod and the rear bottom rod, which is respectively pivotally connected to the first side connecting rod and the rear bottom rod,
one end of the first intermediate rod is pivotally connected to a middle section of the first side connecting rod, and the other end is pivotally connected to the front or rear bottom rods.

7. The quick folding cart according to claim 3, wherein the locking mechanism comprises a second connecting column connected to the first linkage element at one end, and a second folding pivot seat fixed on the other end of the second connecting column, and the locking mechanism further comprises a second sliding sleeve capable of sliding on two sides of the front frame and/or on two sides of the rear frame, and a second side connecting rod is arranged between the second folding pivot seat and the second sliding sleeve and pivotally connected with the second folding pivot seat and the second sliding sleeve, the second side connecting rod is equipped with a pivot hole.

8. The quick folding cart according to claim 7, wherein the locking mechanism further comprises a locking sleeve that slides on the front bottom rod and/or the rear bottom rod, one end of the locking sleeve is pivotally connected to one end of a second intermediate rod, and the other end of the second intermediate rod pivotally connects and rotates with the pivot hole.

9. The quick folding cart according to claim 8, wherein the locking mechanism further comprises locking components disposed within the front bottom rod and the rear bottom rod on one side away from a folding direction of the folding device, the locking components are configured limiting the sliding of the locking sleeve on the front bottom rod or the rear bottom rod.

10. The quick folding cart according to claim 4, wherein each first folding rod is configured with a sliding groove, and the folding device further comprises two first sliding sleeves respectively slidingly arranged on each first folding rod, and the first sliding sleeve is configured to slide within a range of the sliding groove, and the lifting component is pivotally connected to each first sliding sleeve,
the folding device further comprises a first driving element arranged inside the first sliding sleeve and sliding with the first sliding sleeve, a first connecting element is configured between the first driving element and locking component for connecting the first driving element and locking component, when the lifting component is actuated, the locking component release restriction to the locking sleeve.

11. The quick folding cart according to claim 10, wherein the locking component is configured with a movable cavity and a movable hole pivotally connected to the movable cavity, and the locking component further comprises a stopper piece that slides in the movable cavity when pulled by the first connecting element, the shape of the stopper piece corresponds to the movable hole and is capable of blocking the sliding of the locking sleeve,
a reset component is configured between the stopper piece and the movable cavity for resetting the stopper piece and further re-limiting the sliding of the locking sleeve.

12. The quick folding cart according to claim 11, wherein the locking member is configured with a movable cavity and a movable hole pivotally connected to the movable cavity, and the locking component further comprises a stopper piece having a cross-sectional shape defined by one arcuate side and one vertical side, and sized to correspond to the movable hole, one side of the stopper piece is configured with a movable platform configured to contact the first connecting element and the reset component, wherein the movable platform is configured to slide cooperatively within the movable cavity.

13. The quick folding cart according to claim 3, wherein the two first folding rods are symmetrical about the first linkage element or symmetrical about the second linkage element, the upper and lower sides of the front frame are fixed with first upper pivot joint seats and first lower pivot joint seats respectively pivotally connected to the front top rod and the front bottom rod, and the upper and lower sides of the rear frame are fixed with second upper pivot joint seats and second lower pivot joint seat respectively pivotally connected to the rear top rod and the rear bottom rod.

14. The quick folding cart according to claim 2, wherein the folding device comprises two second folding rods respectively arranged between the two front bottom rods and/or between the two rear bottom rods, and a pulling component configured to drive the second folding rods and thereby actuate the locking mechanism to release a rotational constraint, or
the folding device comprises a second folding rod disposed between the two second linkage elements, and a pulling component configured to drive the second folding rod and thereby actuate the locking mechanism to release a rotational constraint,
wherein when the pulling component is actuated, the locking mechanism is subjected to a force and releases the rotational constraint between the front bottom rod and the front frame, and between the rear bottom rod and the rear frame, thereby causing the front bottom rod and the rear bottom rod to fold the cart.

15. The quick folding cart according to claim 14, wherein the locking mechanism further comprises locking components disposed within the front bottom rod and the rear bottom rod on one side away from a folding direction of the folding device, two locking grooves are configured on the second folding rod,
the folding device further comprises two third sliding sleeves that correspond to the locking grooves and are slidable within the locking grooves, and two second driving elements are arranged inside the third sliding sleeves and sliding with the third sliding sleeves, respectively,
each of the third sliding sleeve is slidable within the corresponding locking grooves, and a second connecting element is provided between each second driving element and the corresponding locking component on the same side, respectively connecting the second driving elements and the locking component.
